(19) United States
(12) Patent Application Publication
(10) Pub. No.: US 2010/0245377 A1
(43) Pub. Date: Sep. 30, 2010

(54) COLOR CONVERTER, COLOR CONVERSION METHOD AND COMPUTER READABLE MEDIUM

(75) Inventors: Akihiro ITO, Ashigarakami-gun (JP); Hidetoshi Kawashima, Ebina-shi (JP); Yuichi Nishikuni, Ebina-shi (JP); Toshio Koriyama, Ebina-shi (JP); Toshie Kobiyama, Saitama-shi (JP); Kiyoshi Une, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/569,922

(22) Filed: Sep. 30, 2009

(30) Foreign Application Priority Data
Mar. 25, 2009 (JP) 2009-073592

(51) Int. Cl. G09G 5/02

(52) U.S. Cl. 345/589

(57) ABSTRACT

The color converter is provided with: a color conversion parameter generation unit that generates a color conversion parameter based on a source profile and a destination profile, the source profile indicating a color reproduction characteristic of a device used for generating an input image, the destination profile indicating a color reproduction characteristic of a device used for generating an output image; a conversion unit that converts color data of the input image into color data of the output image by using the color conversion parameter generated by the color conversion parameter generation unit; and a memory that stores the color conversion parameter generated by the color conversion parameter generation unit so that the color conversion parameter is associated with identification information of the source profile.

### CROSS REFERENCE TO RELATED APPLICATIONS

This application is based on and claims priority under 35 USC §119 from Japanese Patent Application No. 2009-073592 filed Mar. 25, 2009.

### BACKGROUND

1. Technical Field

The present invention relates to a color converter, a color conversion method and a computer readable medium storing a program.

2. Related Art

There is known a color converter in which a color conversion parameter is generated on the basis of a source profile and a destination profile every time a source profile is selected.

### SUMMARY

According to an aspect of the present invention, there is provided a color converter including: a color conversion parameter generation unit that generates a color conversion parameter based on a source profile and a destination profile, the source profile indicating a color reproduction characteristic of a device used for generating an input image, the destination profile indicating a color reproduction characteristic of a device used for generating an output image; a conversion unit that converts color data of the input image into color data of the output image by using the color conversion parameter generated by the color conversion parameter generation unit; and a memory that stores the color conversion parameter generated by the color conversion parameter generation unit so that the color conversion parameter is associated with identification information of the source profile.

### BRIEF DESCRIPTION OF THE DRAWINGS

Exemplary embodiment (s) of the present invention will be described in detail based on the following figures, wherein:

FIG. 1 is a diagram showing a hardware configuration example of an image processing apparatus to which the exemplary embodiment of this invention is applied;

FIG. 2 is a block diagram showing a functional configuration example of a color converter to which the exemplary embodiment of this invention is applied;

FIGS. 3A and 3B show a first example of the basic characteristic used in the exemplary embodiment of this invention;

FIG. 4 shows a second example of the basic characteristic used in the exemplary embodiment of this invention;

FIG. 5 shows a first example of an evaluation in the basic characteristic evaluation unit of the exemplary embodiment of this invention;

FIGS. 6A and 6B are graphs for explaining the tone correction in a case where the evaluation such as a first example is done in the basic characteristic evaluation unit of the exemplary embodiment of this invention;

FIG. 7 shows a second example of an evaluation in the basic characteristic evaluation unit of the exemplary embodiment of this invention;

FIGS. 8A and 8B are graphs for explaining the tone correction in a case where the evaluation such as a second example is done in the basic characteristic evaluation unit of the exemplary embodiment of this invention;

FIGS. 9A to 9D are diagrams each schematically showing an aspect for determining whether or not a color conversion parameter stored in the color conversion parameter storage unit according to the exemplary embodiment of this invention is reused;

FIGS. 10A and 10B are diagrams for explaining determination of a color conversion parameter as a deletion target among the color conversion parameters stored in the color conversion parameter storage unit;

FIG. 11 is a table showing a calculation example of a non-closeness indicator used in the exemplary embodiment of this invention;

FIG. 12 shows a calculation example of non-closeness scores used in the exemplary embodiment of this invention;

FIG. 13-1 is a flowchart showing an operation example of the color converter in the exemplary embodiment of this invention; and

FIG. 13-2 is a flowchart showing an operation example of the color converter in the exemplary embodiment of this invention.

### DETAILED DESCRIPTION

An exemplary embodiment of the present invention will be described below in detail with reference to the accompanying drawings.

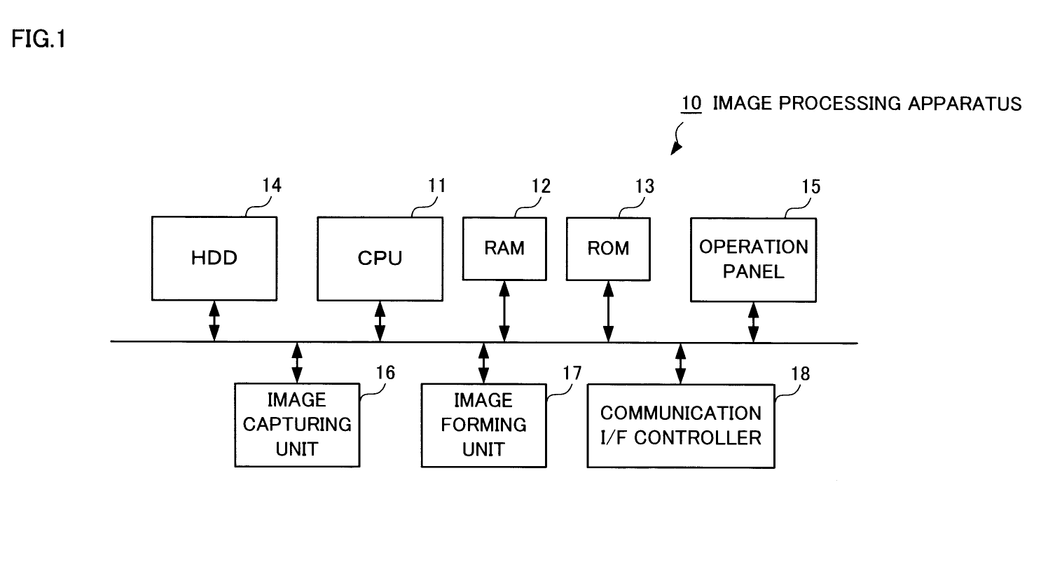

FIG. 1 is a diagram showing a hardware configuration example of an image processing apparatus 10 to which the exemplary embodiment is applied.

As shown in FIG. 1, the image processing apparatus 10 includes a central processing unit (CPU) 11, a random access memory (RAM) 12, a read only memory (ROM) 13, a hard disk drive (HDD) 14, an operation panel 15, an image capturing unit 16, an image forming unit 17 and a communication interface controller (hereinafter, referred to as a “communication I/F controller”) 18.

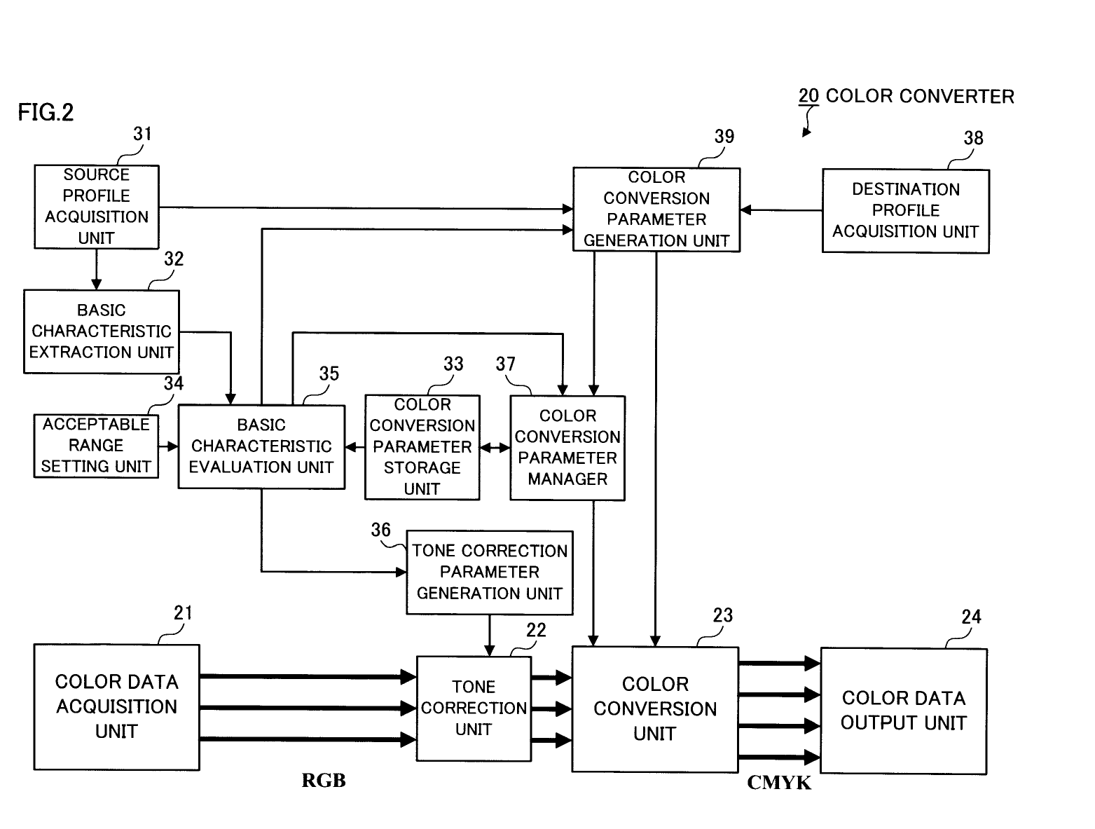

The CPU 11 loads various programs stored in the ROM 13 and the like into the RAM 12, and then executes the programs, thereby implementing functions to be described later with reference to FIG. 2.

The RAM 12 is a memory that is used as a working memory or the like for the CPU 11.

The ROM 13 is a memory that stores, therein, the various programs executed by the CPU 11.

The HDD 14 is, for example, a magnetic disk device that stores, therein, image data captured by the image capturing unit 16 or image data used for forming an image in the image forming unit 17, or the like.

The operation panel 15 is, for example, a touch panel that displays various types of information and receives an operation input by a user.

The image capturing unit 16 captures an image recorded on a recording medium such as a paper. The image capturing unit 16 herein is, for example, a scanner. In addition, the scanner to be used may employ one of the following two systems: a CCD system in which reflected light of light emitted from an light source and directed at an original is reduced by use of a lens and is then received by a charge coupled device (CCD); and a CIS system in which reflected light of light beams sequentially emitted from LED light sources and directed at an original is received by a contact image sensor (CIS).

The image forming unit 17 forms an image on a recording medium such as a paper. The image forming unit 17 herein is, for example, a printer. Moreover, the printer to be used may employ one of the following two methods: an electrophotographic method in which an image is formed by transferring toner attached to a photoconductive drum onto a recording medium; and an ink jet method in which an image is formed by ejecting ink onto a recording medium.

The communication I/F controller 18 transmits and receives various types of information to and from other devices via a network.

Incidentally, the aforementioned image processing apparatus 10 receives, as an input image, an image captured by the image capturing unit 16 or an image received by the communication I/F controller 18. At this time, the input image includes a color profile embedded therein. In the color profile (hereinafter, referred to as a “source profile”), a color reproduction characteristic of a device used to generate the image is described.

Meanwhile, the image processing apparatus 10 forms an image by use of a color profile in which a color reproduction characteristic unique to the apparatus is described (hereinafter, referred to as a “destination profile”).

Accordingly, the image forming apparatus 10 converts color data of the input image on the basis of the source profile, and thereafter, converts the converted color data on the basis of the destination profile, thereby generating color data of an output image. At this time, a color conversion parameter obtained by combining the source profile and the destination profile is generated, and color conversion of an image is performed by use of the color conversion parameter. Thereby, an efficient color conversion may be achieved.

However, the source profile is dependent on conditions under which the input image is generated, so that the source profile may differ depending on the input image in some cases. For example, even when input images include RGB signals of the same values, the colors actually reproduced by the signals may be different in some cases.

If a color conversion parameter is to be generated in consideration of the aforementioned case every time a source profile is specified, the same color conversion parameter may be generated multiple times in some cases, which results in inefficient processing.

In this respect, in the present exemplary embodiment, a history of a generated color conversion parameter is recorded. In other words, in a case where a color conversion parameter is generated by use of a specified source profile, and color conversion is performed by use of the color conversion parameter, the color conversion parameter is stored so as to be associated with identification information (a basic characteristic, for example) of the specified source profile. In this manner, the same color conversion parameter is not repeatedly generated, and the color conversion parameter that has been already generated may be reused.

Note that, even in a case where no substantial change exists in a source profile, the color conversion parameter slightly changes due to a slight change in sampling or measurement of the color at the time of generating the color conversion parameter. Accordingly, when source profiles may be treated as substantially the same source profile, re-generation of the color conversion parameter is avoided. Thereby processing efficiency is improved.

Furthermore, depending on an application, a higher priority may be given to efficiency rather than some degree of a color difference in some cases. Thus, an acceptable range in accordance with an application is set, and if a difference between source profiles is within the acceptable range, the already generated color conversion parameter is reused to improve efficiency. In other words, in a case where a difference between a basic characteristic of a newly specified source profile and a basic characteristic of an existing one is within the set acceptable range, a new conversion parameter is not generated, and the color conversion parameter associated with the specified source profile is used.

Next, a description will be given in more details of a color converter that performs the aforementioned operations.

FIG. 2 is a block diagram showing a functional configuration example of a color converter 20. Note that, this color converter 20 is achieved in the image processing apparatus 10 when the CPU 11 of the image processing apparatus 10 executes a color conversion program stored in the ROM 13 by loading the program into the RAM 12.

As shown in FIG. 2, the color converter 20 includes a color data acquisition unit 21, a tone correction unit 22, a color conversion unit 23, and a color data output unit 24. In addition, the color converter 20 includes a source profile acquisition unit 31, a basic characteristic extraction unit 32, a color conversion parameter storage unit 33, an acceptable range setting unit 34, a basic characteristic evaluation unit 35, a tone correction parameter generation unit 36, a color conversion parameter manager 37, a destination profile acquisition unit 38, and a color conversion parameter generation unit 39.

The color data acquisition unit 21 acquires color data from an input image.

The tone correction unit 22 performs tone correction for each color signal included in the color data acquired by the color data acquisition unit 21. In the present exemplary embodiment, the tone correction unit 22 is provided as an example of a correction unit that corrects a tone characteristic of color data.

The color conversion unit 23 performs color conversion for the color data acquired by the color data acquisition unit 21, or color data after tone correction in a case where the tone correction is performed by the tone correction unit 22. In the present exemplary embodiment, the color conversion unit 23 is provided as an example of a conversion unit that converts color data.

The color data output unit 24 outputs, to the image forming unit 17 (refer to FIG. 1), color data that has been subjected to color conversion by the color conversion unit 23.

The source profile acquisition unit 31 acquires a source profile from an input image.

The basic characteristic extraction unit 32 extracts a basic characteristic from the source profile acquired by the source profile acquisition unit 31. Note that, a detailed description of the basic characteristic will be given later. In the present exemplary embodiment, the basic characteristic extraction unit 32 is provided as an example of an extraction unit that extracts a basic characteristic from a source profile.

The color conversion parameter storage unit 33 stores the basic characteristic extracted by the basic characteristic extraction unit 32 and color conversion parameter generated by the later described color conversion parameter generation unit 39 so that the basic characteristic and the color conversion parameter are associated with each other. In the present exemplary embodiment, the color conversion parameter storage unit 33 is provided as an example of a memory that stores color conversion parameters therein.

The acceptable range setting unit 34 sets an acceptable range for a difference between the basic characteristic extracted by the basic characteristic extraction unit 32 (hereinafter, referred to as an “input basic characteristic”) and a basic characteristic stored in the color conversion parameter storage unit 33 (hereinafter, referred to as a “stored basic characteristic”). At this time, the acceptable range may be set in accordance with a request from a user. In addition, the acceptable range may be set for each of a color reproduction characteristic of each color signal included in the color data and a tone characteristic of each color signal. In the present exemplary embodiment, the input basic characteristic is used as an example of a first basic characteristic, and the stored basic characteristic is used as an example of a second basic characteristic. Moreover, the acceptable range is used as an example of a threshold, and the acceptable range setting unit 34 is provided as an example of a setting unit that sets a threshold.

The basic characteristic evaluation unit 35 evaluates whether a difference between the input basic characteristic and the stored basic characteristic is smaller than the acceptable range or not. At this time, the evaluation may be performed for each of the reproduction characteristic of each color signal included in color data and the tone characteristic of each color signal. In the present exemplary embodiment, the basic characteristic evaluation unit 35 is provided as an example of a determination unit that determines whether or not the conversion unit uses a stored color conversion parameter, or whether or not the correction unit corrects a tone characteristic of color data.

The tone correction parameter generation unit 36 generates a tone correction parameter used in tone correction performed by the tone correction unit 22.

The color conversion parameter manager 37 manages color conversion parameters stored in the color conversion parameter storage unit 33. Specifically, when the basic characteristic evaluation unit 35 determines that a color conversion parameter is reusable, the color conversion parameter manager 37 reads out color conversion parameter stored so as to be associated with the basic characteristic specified by the basic characteristic evaluation unit 35, and sets the color conversion parameter in the color conversion unit 23. In addition, when a color conversion parameter generated by the color conversion parameter generation unit 39 is to be stored in the color conversion parameter storage unit 33, the color conversion parameter manager 37 determines whether or not a new color conversion parameter is storable in the color conversion parameter storage unit 33, and if the new color conversion parameter is not storable, the color conversion parameter manager 37 determines a color conversion parameter as a deletion target. In the present exemplary embodiment, the color conversion parameter manager 37 is provided as an example of a controller that controls deletion of a specific color conversion parameter.

The destination profile acquisition unit 38 acquires a destination profile from information related to a device. Here, the information is stored in the HDD 14 (refer to FIG. 1), for example.

The color conversion parameter generation unit 39 generates a color conversion parameter on the basis of the source profile acquired by the source profile acquisition unit 31 and the destination profile acquired by the destination profile acquisition unit 38. Then, the color conversion parameter generation unit 39 sets the color conversion parameter in the color conversion unit 23, and also passes the color conversion parameter to the color conversion parameter manager 37 in order that the color conversion parameter may be stored in the color conversion parameter storage unit 33. In the present exemplary embodiment, the color conversion parameter generation unit 39 is provided as an example of a color conversion parameter generation unit that generates a color conversion parameter.

Here, a description will be specifically given of the basic characteristic extracted from the source profile by the basic characteristic extraction unit 32 and the acceptable range to be set for the basic characteristic by the acceptable range setting unit 34.

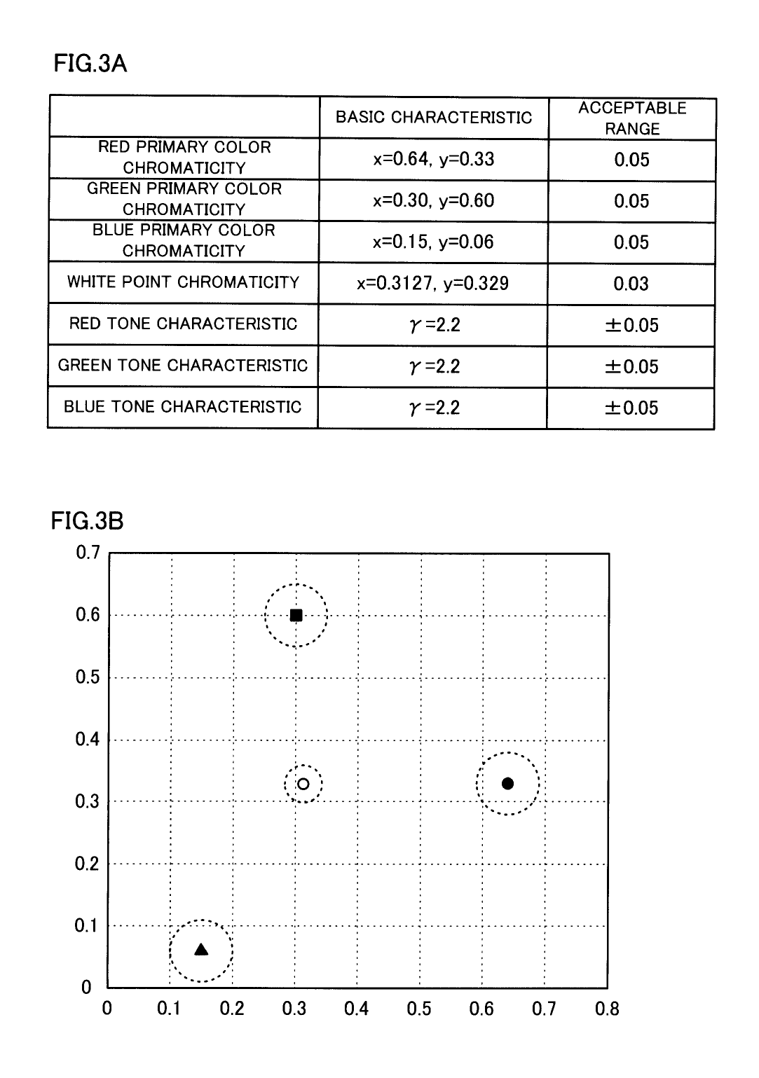

FIGS. 3A and 3B show a specific example in a case where the device type of the source profile is a display (a first example of the basic characteristic).

FIG. 3A shows examples of a basic characteristic and acceptable ranges. The basic characteristic includes chromaticity coordinates x, y of each of the RGB primary colors, chromaticity coordinates x, y of the white point and RGB tone characteristics γ. Here, the chromaticity coordinates x, y of each of the RGB primary colors and the chromaticity coordinates x, y of the white point are examples of reproduction characteristics of main colors, and the tone characteristics γ of the RGB primary colors are examples of tone characteristics of the main colors. In addition, the acceptable range is set for each of the RGB primary colors, the white point, and the tone characteristics of the RGB primary colors.

FIG. 3B shows a chromaticity diagram in which points corresponding to the chromaticity coordinates x, y of each of the RGB primary colors and the chromaticity coordinates x, y of the white point are plotted, and the acceptable ranges for the respective RGB primary colors and the white point are shown with circles each having a corresponding one of the points of the RGB primary colors and the white point as the center of the circle. Note that, in FIG. 3B, the black circle, the black square, the black triangle and the white circle correspond to the primary colors R, G and B and the white point, respectively.

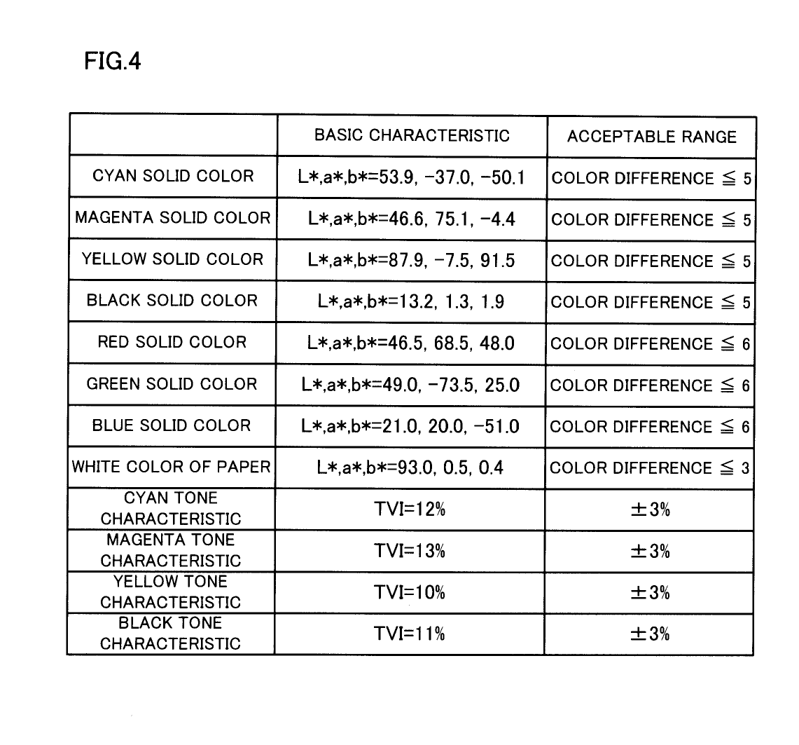

In addition, FIG. 4 shows a specific example in a case where the device type of the source profile is a printer (a second example of the basic characteristic).

FIG. 4 shows examples of a basic characteristic and acceptable ranges. Firstly, the basic characteristic includes L*a*b* values of CMYK solid colors, which are the primary colors, L*a*b* values of RGB solid colors, which are the secondary colors, L*a*b* values of the white color of paper, and tone value increases (TVIs) of tone characteristics of CMYK, which are the primary colors. Here, the L*a*b* values of CMYK solid colors, the L*a*b* values of RGB solid colors and the L*a*b* values of the white color of the paper are examples of color reproduction characteristics of the main colors, and the tone characteristics TVI of CMYK are examples of the tone characteristics of the main colors. Moreover, the acceptable range is set for each of the CMYK solid colors, the RGB solid colors, the white color of the paper, and the CMYK tone characteristics TVI.

Next, a description will be specifically given of evaluation performed by the basic characteristic evaluation unit 35.

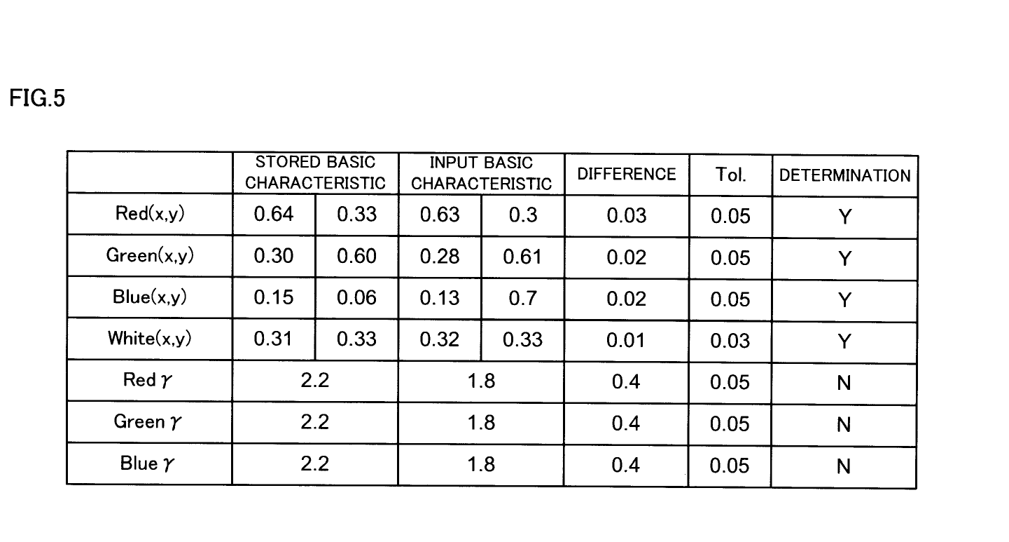

FIG. 5 shows a specific example in a case where the device type of the source profile is a display (a first example of an evaluation in the basic characteristic evaluation unit 35).

FIG. 5 shows values in a stored basic characteristic, values in an input basic characteristic and differences between these values corresponding to each other, for the RGB and white chromaticity coordinates x, y and the RGB tone characteristics γ. Moreover, acceptable ranges (TOL.) set by the acceptable range setting unit 34 are also shown in FIG. 5.

Then, the basic characteristic evaluation unit 35 compares the differences and the acceptable ranges corresponding to each other, thereby evaluating the two basic characteristics. In FIG. 5, for the RGB and white chromaticity coordinates x, y, the differences are determined to be smaller than the respective acceptable ranges, so that “Y” is shown in each of determination fields. On the other hand, for the RGB tone characteristics γ, the differences are determined to be not smaller than the respective acceptable ranges, so that “N” is shown in each of determination fields.

In this case, since only the differences of the tone characteristics are not smaller than the acceptable ranges, the color conversion parameter stored in the color conversion parameter storage unit 33 may be reused if the tone correction is performed by the tone correction unit 22.

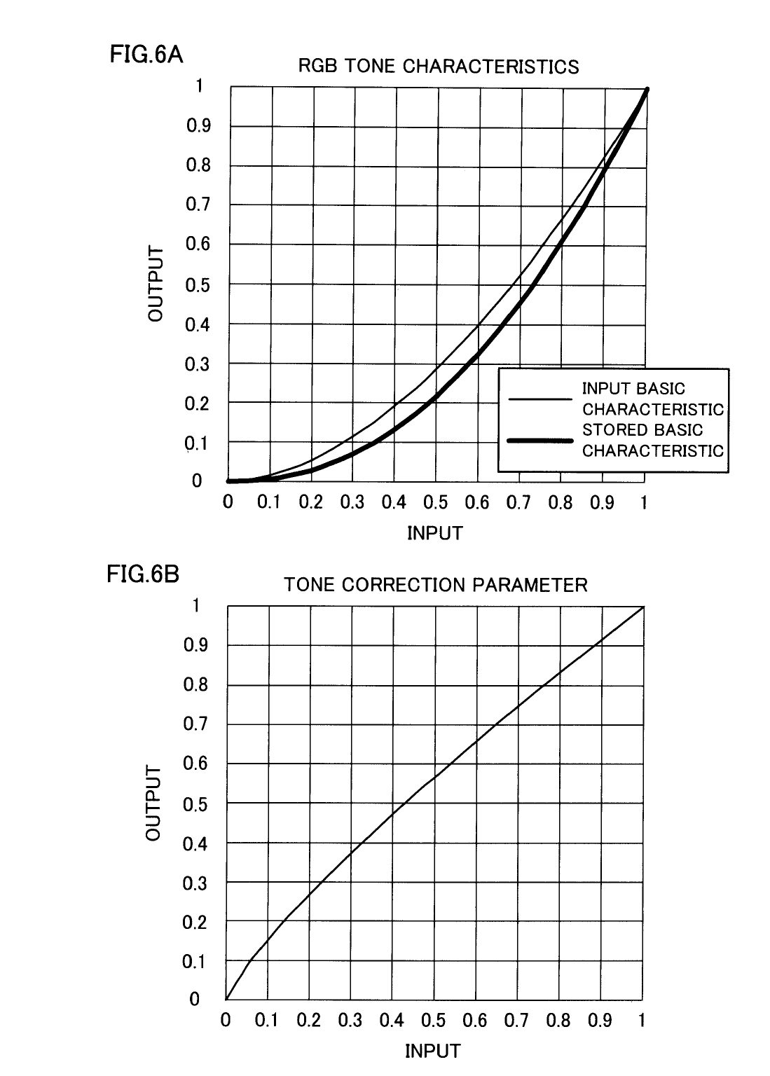

FIGS. 6A and 6B are graphs for explaining the tone correction in a case where the evaluation such as a first example is done in the basic characteristic evaluation unit 35.

FIG. 6A shows gamma curves respectively representing the RGB tone characteristics in the stored basic characteristic and the RGB tone characteristics in the input basic characteristic. In FIG. 6A, the bold line shows the gamma curve in the stored basic characteristic, that is, the gamma curve where γ=2.2. In addition, the thin line shows the gamma curve in the input basic characteristic, that is, the gamma curve where γ=1.8.

Meanwhile, FIG. 6B shows a tone correction parameter (gamma correction curve) for performing tone correction of γ=0.818 (≈1.8/2.2). Specifically, even in a case where a signal having a tone characteristic γ=1.8 is inputted, the color conversion parameter stored in the color conversion parameter storage unit 33 may be reused without any modification if tone correction is performed on the signal by use of this tone correction parameter to obtain the tone characteristic γ=2.2 before color conversion is performed.

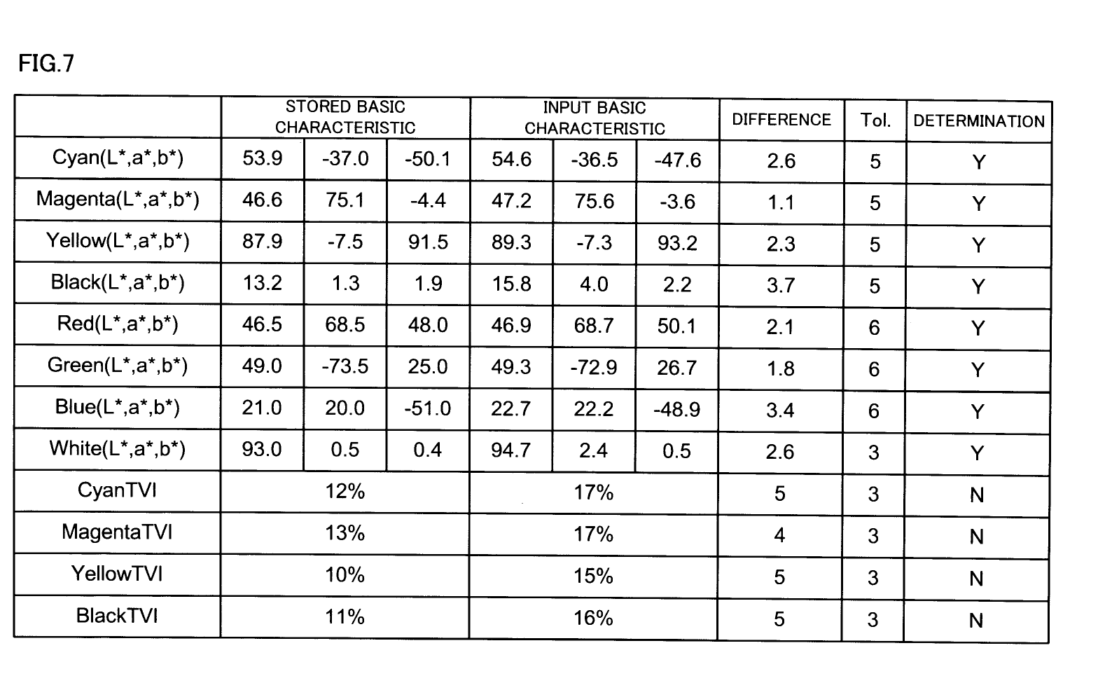

Moreover, FIG. 7 shows a specific example in a case where the device type of the source profile is a printer (a second example of an evaluation in the basic characteristic evaluation unit 35).

FIG. 7 shows values in a stored basic characteristic, values in an input basic characteristic, and differences between these values corresponding to each other, for the L*a*b* values of CMYK, RGB and white and the CMYK tone characteristics TVI. Moreover, acceptable ranges (TOL.) set by the acceptable range setting unit 34 are also shown in FIG. 7.

Then, the basic characteristic evaluation unit 35 compares the differences and the acceptable ranges corresponding to each other, thereby evaluating the two basic characteristics. In FIG. 7, for the L*a*b* values of CMYK, RGB and white, the differences are determined to be smaller than the respective acceptable ranges, so that “Y” is shown in each of determination fields. For the CMYK tone characteristics TVI, the differences are determined to be not smaller than the respective acceptable ranges, so that “N” is shown in each of determination fields.

Here, as shown in FIG. 7, a description will be given of a determination method of determining whether or not tone characteristics in the case where the device type of the source profile is a printer are matched with each other.

Firstly, a description will be given of a determination method based on an average color difference or the largest color difference of the tone data of a primary color. For example, when cyan (C) is set to be the primary color, the L*a*b* values of the stored basic characteristics, and the L*a*b* values of the input basic characteristics, are obtained for each of 3%, 7%, 10%, 15%, 20%, 25%, 30%, 40%, 50%, 60%, 70%, 80% and 90% of cyan (C), and the color differences between these L*a*b* values are obtained as well. Then, on the basis of the average value among all of the color differences or the largest value of these color differences, determination whether or not the tone characteristics are matched with each other is performed in this method.

Secondly, a description will be given of a determination method based on the color difference of 50% of tone data of the primary color. For example, when cyan (C) is set to be the primary color, the L*a*b* values of the stored basic characteristic, and the L*a*b* values of the input basic characteristic, are obtained for 50% of cyan (C) and the differences between these L*a*b* values are obtained as well. Then, on the basis of these color differences, determination whether or not the tone characteristics are matched with each other is performed in this method.

Thirdly, a description will be given of a determination method based on 50% TVI (Tone Value Increase). The example shown in FIG. 7 employs this method.

Note that, in this patent description, a TVI is defined as a tone characteristic represented by the amount of reduction in reflectivity, which occurs due to dot gain. In particular, 50% of TVI is used as the representative value. The reflectivity when the dot area ratio is equal to 50% is supposed to be the reflectivity that is just a middle value (50%) between the reflectivity when the dot area ratio is 0% and the reflectivity when the dot area ratio is 100%. However, in reality, the reflectivity becomes lower than the reflectivity of 50% due to influence of dot gain. The difference in these reflectivities is 50% TVI. The 50% TVIs are calculated by the following equations using values of tristimulus values instead of reflectivities.

A %=100%×(X₀−Xₜ)/(X₀−Xₛ)−50% (1)

A %=100%×(Y₀−Yₜ)/(Y₀−Yₛ)−50% (2)

A %=100%×(Z₀−Zₜ)/(Z₀−Zₛ)−50% (3)

Here, (1) is the equation for calculating 50% TVI for cyan, (2) is the equation for calculating 50% TVI for magenta and black and (3) is the equation for calculating 50% TVI for yellow. In addition, each of X, Y and Z indicates a tristimulus value, and shows the tristimulus value of the white of the paper when the suffix is 0, the tristimulus value of an image of the dot area ratio of 50% when the suffix is t, and the tristimulus value of a solid image when the suffix is s.

In the case shown in FIG. 7 as well, since only the differences of the tone characteristics are not smaller than the acceptable ranges, the color conversion parameter stored in the color conversion parameter storage unit 33 may be reused if tone correction is performed by the tone correction unit 22.

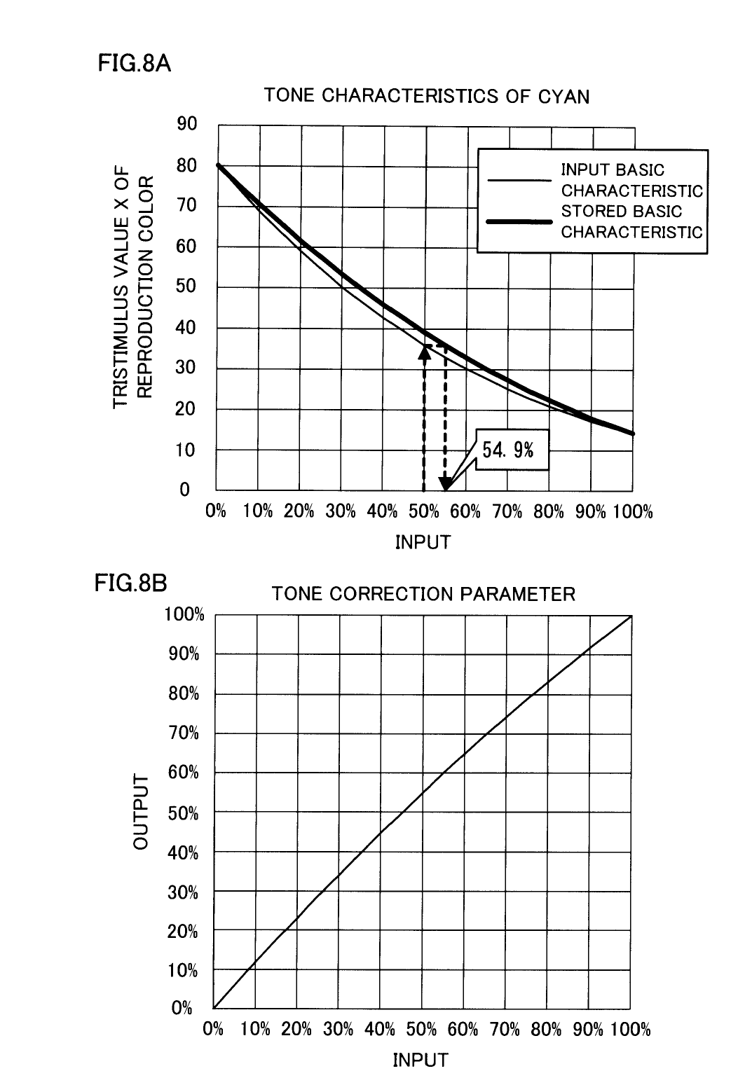

FIGS. 8A and 8B are graphs for explaining the tone correction in a case where the evaluation such as a second example is done in the basic characteristic evaluation unit 35.

FIG. 8A shows tone characteristic curves respectively representing tone characteristics of cyan in the stored basic characteristic and the input basic characteristic. The bold line shows the tone characteristic curve in the stored basic characteristic. The thin line shows the tone characteristic curve in the input basic characteristic.

Meanwhile, FIG. 8B shows a tone correction parameter (tone correction curve) generated from the tone characteristics in the input basic characteristic and the stored basic characteristic. This tone correction curve may be obtained by a procedure shown by broken lines in FIG. 8A. Specifically, a tristimulus value X for the input value of 50% is obtained by use of the tone characteristic curve in the input basic characteristic, first. Next, an input value for this tristimulus value X is obtained by use of the tone characteristic curve in the stored basic characteristic. By this operation, the input value of 54.9% is obtained. Accordingly, by performing tone correction in which the input value of 50% is corrected to be the input value of 54.9%, the color conversion parameter stored in the color conversion parameter storage unit 33 becomes reusable without any modification.

Next, a description will be given of management of the color conversion parameters stored in the color conversion parameter storage unit 33.

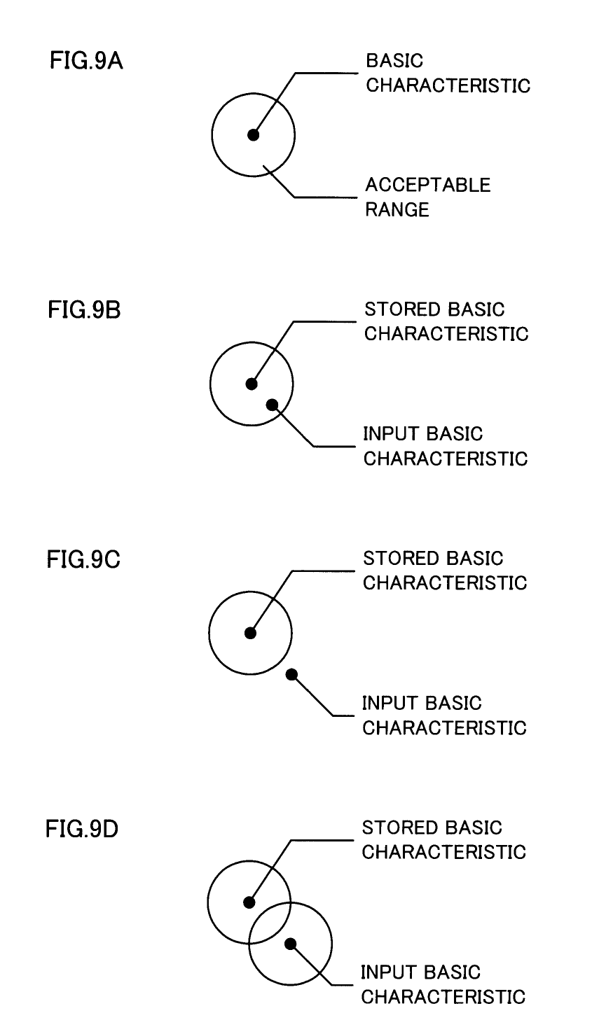

FIGS. 9A to 9D are diagrams each schematically showing an aspect for determining whether or not a color conversion parameter stored in the color conversion parameter storage unit 33 is reused.

Here, as shown in FIG. 9A, a basic characteristic is shown by a dot, and an acceptable range is shown by a circle.

Firstly, consider a case where the stored basic characteristic and the input basic characteristic are in the relationship as shown in FIG. 9B. In this case, the input basic characteristic is within the acceptable range of the stored basic characteristic, so that a color conversion parameter cached in the color conversion parameter storage unit 33 is used.

Next, consider a case where the stored basic characteristic and the input basic characteristic are in the relationship as shown in FIG. 9C. In this case, the input basic characteristic is outside the acceptable range of the stored basic characteristic, so that a color conversion parameter for the newly inputted source profile is generated, and then is registered if the color conversion parameter storage unit 33 has a margin.

Note that, in a case where the input basic characteristic is registered in the color conversion parameter storage unit 33, an acceptable range exists for this input basic characteristic as well. Then, there is a case where the acceptable range overlaps with the acceptable range of the stored basic characteristic as shown in FIG. 9D.

However, if the color conversion parameter storage unit 33 has no margin in the case shown in FIG. 9C, it is necessary to determine which color conversion parameter is kept and which color conversion parameter is deleted among the color conversion parameters stored in the color conversion parameter storage unit 33.

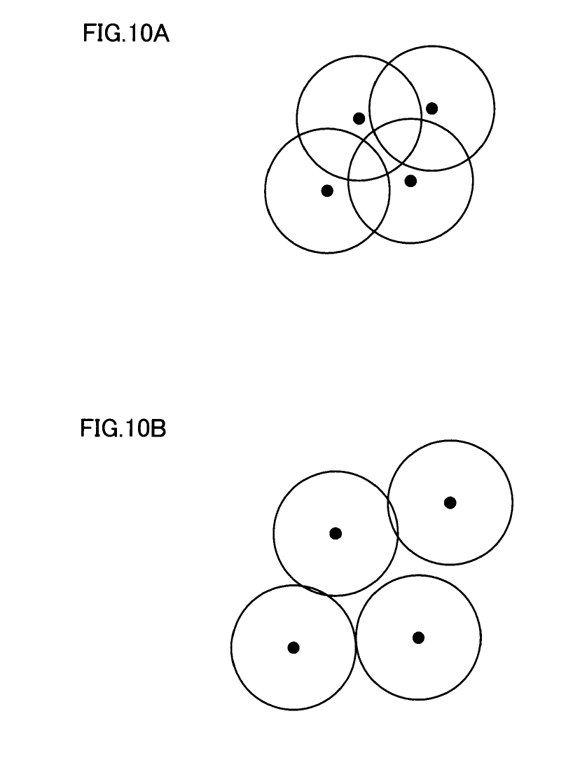

FIGS. 10A and 10B are diagrams showing a concept used to determine which color conversion parameter is kept in a case where the color conversion parameter storage unit 33 are capable of storing multiple color conversion parameters therein but the number of color conversion parameters to be stored therein is limited to a finite number (diagrams for explaining determination of a color conversion parameter as a deletion target among the color conversion parameters stored in the color conversion parameter storage unit 33).

FIG. 10A shows a first state of multiple color conversion parameters stored in the color conversion parameter storage unit 33. FIG. 10B shows a second state of the multiple color conversion parameters stored in the color conversion parameter storage unit 33. The cache hit ratio is higher in a state where basic characteristics are spread in a wide area and the areas of the acceptable ranges overlapping with each other are small as shown in FIG. 10B than in a state where the basic characteristics are congested and the acceptable ranges overlap with one another as shown in FIG. 10A. Specifically, in order to keep the stored color conversion parameters to be spread in a wide area, the degree of matching or similarity (non-closeness, for example) between identification information (basic characteristics, for example) of the respective color conversion parameters is evaluated, and then, a color conversion parameter corresponding to identification information having a high degree of matching or similarity (basic characteristic with a low non-closeness, for example) to other identification information (basic characteristics, for example) may be particularly set to be a deletion target.

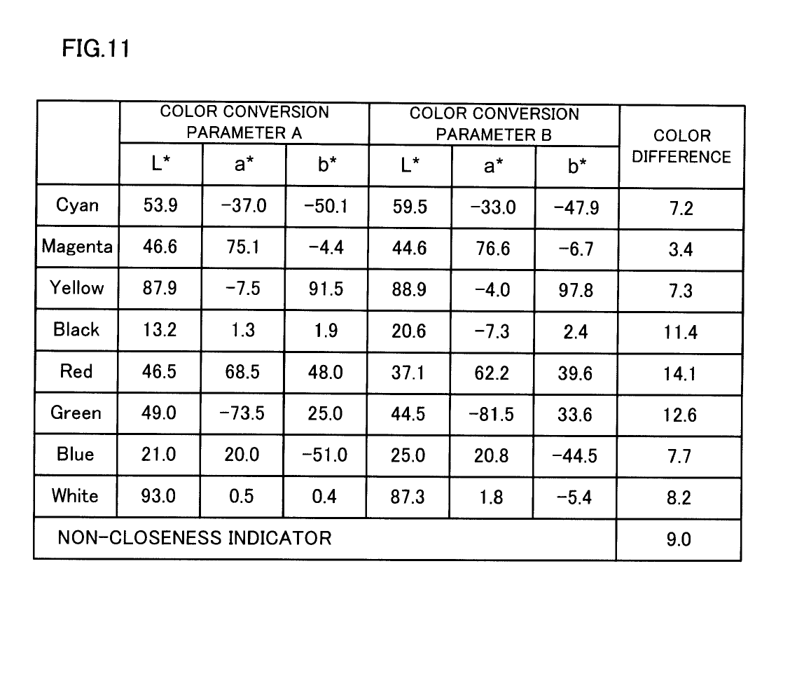

Firstly, an example of calculating the non-closeness between two color conversion parameters is shown in FIG. 11 (a table showing a calculation example of a non-closeness indicator).

In FIG. 11, color differences between the L*a*b* values of the basic characteristic associated with a color conversion parameter A and the L*a*b* values of the basic characteristic associated with a color conversion parameter B are obtained for CMYK, RGB and white. Then, the average value 9.0 of these color differences is set as an indicator (non-closeness indicator) indicating the non-closeness between the color conversion parameter A and the color conversion parameter B.

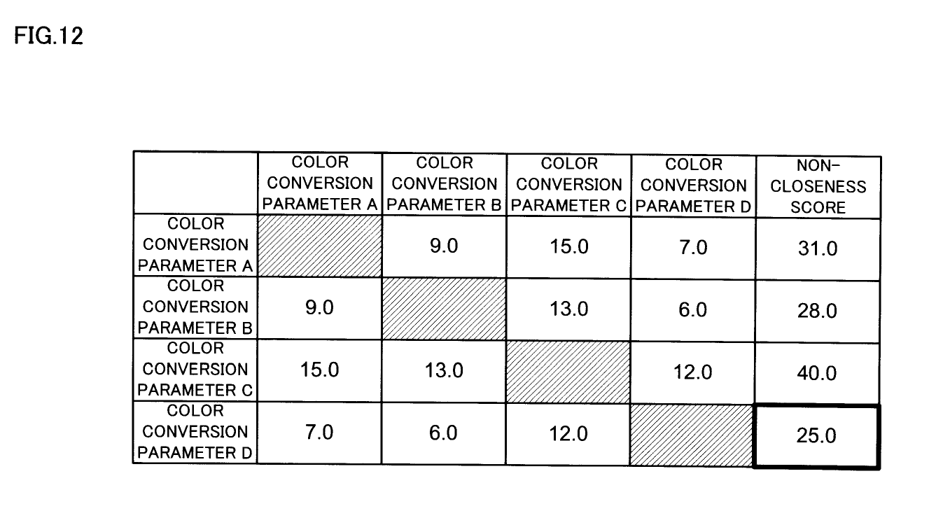

Next, FIG. 12 shows a calculation example of scores (non-closeness scores) each showing the non-closeness between the color conversion parameter and the other color conversion parameters.

In FIG. 12, the calculation as shown in FIG. 11 is performed for each of combinations of two different color conversion parameters selected from color conversion parameters A to D, and thereby, a non-closeness indicator is set. For example, the non-closeness indicator between the color conversion parameters A and B is 9.0 as shown in FIG. 11, so that this value is set in the cell where the color conversion parameters A and B intersect with each other. Moreover, the non-closeness indicators between the color conversion parameters A and C, and between the color conversion parameters A and D are calculated by the method shown in FIG. 11, respectively, and the results are set in the respective cells. Furthermore, each of the non-closeness indicators between any two of the color conversion parameters B, C and D are set in the same manner. Then, the non-closeness score of each of the color conversion parameters is obtained by adding up the non-closeness indicators. In FIG. 12, the non-closeness scores of the color conversion parameters A, B, C and D are 31.0, 28.0, 40.0 and 25.0, respectively. The color conversion parameter D has the lowest non-closeness score among these non-closeness scores as shown by enclosing the cell with a bold line, so that the color conversion parameter D becomes the deletion target.

Next, a description will be given of operations of the color converter 20 in the present exemplary embodiment.

FIGS. 13-1 and 13-2 are flowcharts showing an operation example of the color converter 20.

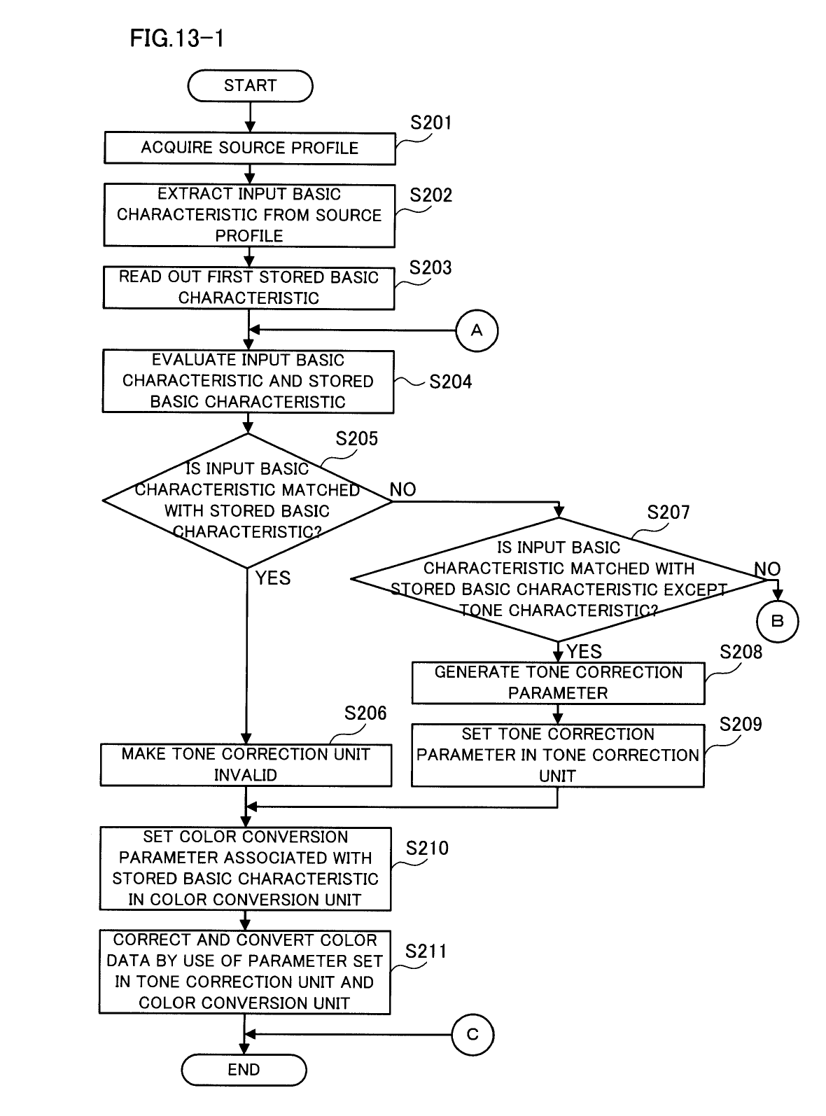

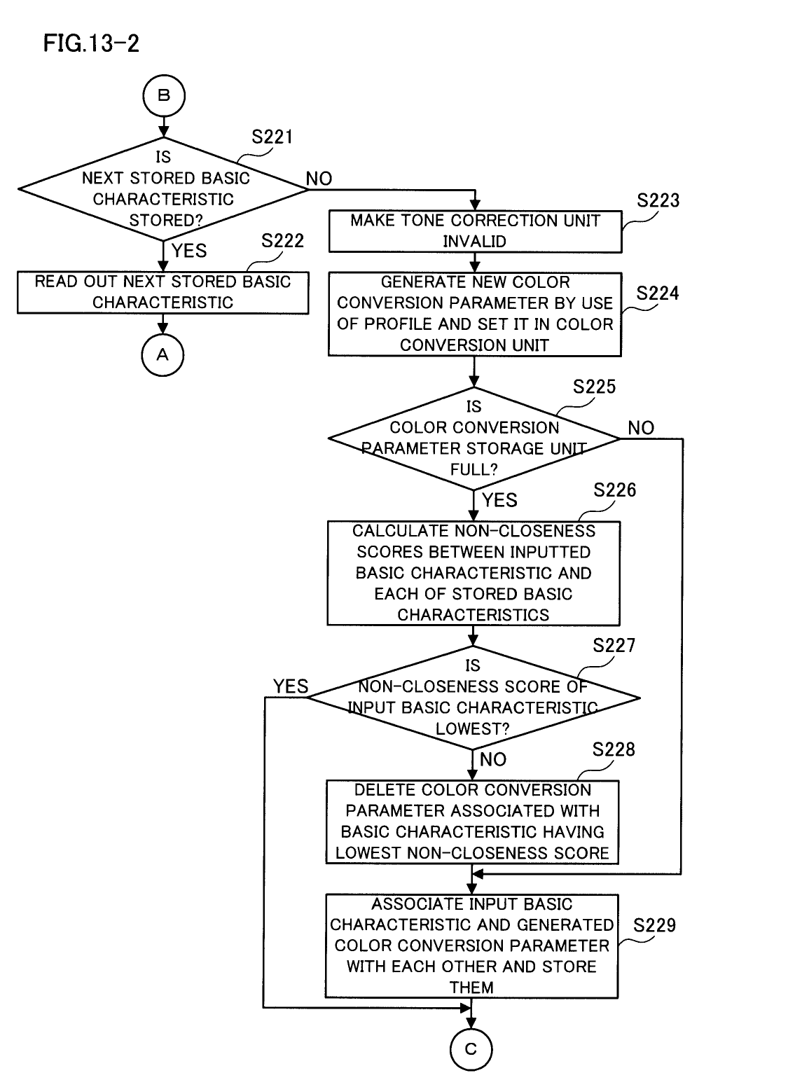

With reference to FIG. 13-1, in the color converter 20, first, the source profile acquisition unit 31 acquires a source profile from an input image and then passes this source profile to the basic characteristic extraction unit 32 (step 201).

Next, the basic characteristic extraction unit 32 extracts an input basic characteristic from the source profile passed by the source profile acquisition unit 31, and then passes this input basic characteristic to the basic characteristic evaluation unit 35 (step 202).

Then, the basic characteristic evaluation unit 35 reads out a first stored basic characteristic from the color conversion parameter storage unit 33 (step 203), and then evaluates the input basic characteristic received in step 202 and the stored basic characteristic read out herein (step 204).

Then, whether or not an evaluation result indicating that the input basic characteristic is matched with the stored basic characteristic is obtained is determined (step 205). Specifically, whether or not the difference between the input basic characteristic and the stored basic characteristic is within an acceptable range set by the acceptable range setting unit 34 is determined.

When the evaluation result indicating that the input basic characteristic is matched with the stored basic characteristic is obtained, that is, when the differences for all of the items are within the acceptable ranges, the operation moves to a processing in which a color conversion parameter stored in the color conversion parameter storage unit 33 is reused. Specifically, the basic characteristic evaluation unit 35 makes the tone correction unit 22 invalid (step 206). More specifically, the basic characteristic evaluation unit 35 instructs the tone correction parameter generation unit 36 to set a through parameter in the tone correction unit 22. Accordingly, the tone correction parameter generation unit 36 sets the through parameter in the tone correction unit 22.

In addition, the basic characteristic evaluation unit 35 passes the stored basic characteristic to the color conversion parameter manager 37, and the color conversion parameter manager 37 reads out a color conversion parameter associated with this stored basic characteristic and then sets the color conversion parameter in the color conversion unit 23 (step 210).

Lastly, the tone correction unit 22 and the color conversion unit 23 perform, respectively, by use of the set parameter, tone correction (through, in this case) and color conversion on the color data acquired from the inputted image by the color data acquisition unit 21 (step 211). Then, the color data after the color conversion is outputted to the image forming unit 17 by the color data output unit 24.

On the other hand, when the evaluation result indicating that the input basic characteristic is matched with the stored basic characteristic is not obtained, that is, when the differences for some of the items are not within the respective acceptable ranges, the basic characteristic evaluation unit 35 determines whether or not an evaluation result indicating that the input basic characteristic is matched with the stored basic characteristic except the tone characteristic is obtained (step 207).

When the evaluation result indicating that the input basic characteristic is matched with the stored basic characteristic except for the tone characteristic is obtained, that is, when the differences for all of the items except the tone characteristic are within the acceptable ranges, the operation moves to a processing in which a color conversion parameter stored in the color conversion parameter storage unit 33 is reused. However, in this case, tone correction is performed before color conversion in order to reuse the color conversion parameter. Specifically, the basic characteristic evaluation unit 35 firstly instructs the tone correction parameter generation unit 36 to generate a tone correction parameter. Accordingly, the tone correction parameter generation unit 36 generates the tone correction parameter (step 208). Then, the tone correction parameter generation unit 36 sets this tone correction parameter in the tone correction unit 22 (step 209).

In addition, the basic characteristic evaluation unit 35 passes the stored basic characteristic to the color conversion parameter manager 37, and the color conversion parameter manager 37 reads out a color conversion parameter associated with this stored basic characteristic and then sets the color conversion parameter in the color conversion unit 23 (step 210).

Lastly, the tone correction unit 22 and the color conversion unit 23 perform, respectively, by use of the set parameter, tone correction and color conversion on the color data acquired from the inputted image by the color data acquisition unit 21 (step 211). Accordingly, the color data after the color conversion is outputted to the image forming unit 17 by the color data output unit 24.

On the other hand, when the evaluation result indicating that the input basic characteristic is matched with the stored basic characteristic except the tone characteristic is not obtained, that is, differences for some of the items are not within the acceptable ranges even though the tone characteristic is excluded from the items to be evaluated, the operation moves to a processing shown in FIG. 13-2.

Specifically, the basic characteristic evaluation unit 35 first determines whether or not the next stored basic characteristic is stored in the color conversion parameter storage unit 33 (step 221). Then, if the next stored basic characteristic is stored, the basic characteristic evaluation unit 35 reads out the next stored basic characteristic (step 222) and repeats the processing in step 204 and thereafter shown in FIG. 13-1. Moreover, if the next stored basic characteristic is not stored, this indicates that no reusable color conversion parameter is stored in the color conversion parameter storage unit 33, so that the operation moves to a processing in which a color conversion parameter is newly generated and stored.

Specifically, the basic characteristic evaluation unit 35 firstly makes the tone correction unit 22 invalid (step 223). More specifically, the basic characteristic evaluation unit 35 instructs the tone correction parameter generation unit 36 to set a through parameter in the tone correction unit 22. Accordingly, the tone correction parameter generation unit 36 sets the through parameter in the tone correction unit 22.

Next, the basic characteristic evaluation unit 35 passes the input basic characteristic to the color conversion parameter manager 37 and also outputs an instruction to generate a new color conversion parameter to the color conversion parameter generation unit 39. By this instruction, the color conversion parameter generation unit 39 generates a new color conversion parameter on the basis of the source profile acquired by the source profile acquisition unit 31 and the destination profile acquired by the destination profile acquisition unit 38, and then sets the new color conversion parameter in the color conversion unit 23 (step 224).

Furthermore, in order to store this new color conversion parameter in the color conversion parameter storage unit 33, the basic characteristic evaluation unit 35 passes this new color conversion parameter to the color conversion parameter manager 37, and the color conversion parameter manager 37 performs a processing for storing this new color conversion parameter in the color conversion parameter storage unit 33.

Specifically, the color conversion parameter manager 37 determines whether or not the color conversion parameter storage unit 33 is in a full state (state where no space for storing the new conversion parameter is available) (step 225). If the color conversion parameter storage unit 33 is determined to be in the full state, the color conversion parameter manager 37 calculates the non-closeness scores between the inputted basic characteristic passed by the basic characteristic evaluation unit 35 in advance and each of the basic characteristics stored in the color conversion parameter storage unit 33 (step 226). Specifically, the non-closeness scores are calculated by use of the method described with reference to FIGS. 11 and 12.

Thereby, the color conversion parameter manager 37 determines whether or not the non-closeness score of the input basic characteristic is the lowest (step 227).

Then, if the non-closeness score of the input basic characteristic is the lowest, the hit ratio is unlikely to increase even when this input basic characteristic is stored after a color conversion parameter already stored in the color conversion parameter storage unit 33 is deleted. Thus, the processing ends without storing the new color conversion parameter in the color conversion parameter storage unit 33.

By contrast, if the non-closeness score of the input basic characteristic is not the lowest, then, among the color conversion parameters already stored in the color conversion parameter storage unit 33, a color conversion parameter associated with a basic characteristic having the lowest non-closeness score is deleted (step 228). Then, the input basic characteristic and the newly generated color conversion parameter are associated with each other and stored (step 229), and then, the processing ends.

In addition, when the color conversion parameter storage unit 33 is not in a full state in step 225, the input basic characteristic passed by the basic characteristic evaluation unit 35 in advance and the color conversion parameter newly generated by the color conversion parameter generation unit 39 are associated with each other and stored (step 229), and then, the processing ends.

The operations of the present exemplary embodiment end as described above.

Note that, the color converter 20 in the present exemplary embodiment does not necessarily include all the constituent elements described as included in the aforementioned color converter 20.

For example, a configuration in which no tone correction is performed when a color conversion parameter is reused is conceivable. In this case, a configuration obtained by excluding the tone correction unit 22 and the tone correction parameter generation unit 36 from the configuration of the color converter 20 described in FIG. 2 is employed.

In addition, a configuration in which the determination whether or not to reuse a color conversion parameter on the basis of the evaluation result of the input basic characteristic and the stored basic characteristic is not performed is also conceivable. In this case, a configuration obtained by further excluding the basic characteristic extraction unit 32, the acceptable range setting unit 34 and the basic characteristic evaluation unit 35 from the configuration of the color converter 20 described in FIG. 2 is employed.

Moreover, in the present exemplary embodiment, a color conversion parameter is cached so as to be associated with identification information (a basic characteristic extracted from the source profile, for example) of the source profile under the assumption that an image including a different source profile embedded therein is inputted. However, a color conversion parameter may be cached so as to be associated with identification information (a basic characteristic extracted from the destination profile, for example) of a destination profile under the assumption that an image is formed on the basis of a different destination profile.

Furthermore, although the color converter 20 is implemented within the image forming apparatus 10 in the present exemplary embodiment, the color converter 20 may be implemented in a computer such as a personal computer (PC).

Note that, the program for achieving the present exemplary embodiment may be provided by a communication unit as a matter of course. Also, it may be provided by use of a recording medium such as a CD-ROM storing the program.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A color converter comprising:
a color conversion parameter generation unit that generates a color conversion parameter based on a source profile and a destination profile, the source profile indicating a color reproduction characteristic of a device used for generating an input image, the destination profile indicating a color reproduction characteristic of a device used for generating an output image;
a conversion unit that converts color data of the input image into color data of the output image by using the color conversion parameter generated by the color conversion parameter generation unit; and
a memory that stores the color conversion parameter generated by the color conversion parameter generation unit so that the color conversion parameter is associated with identification information of the source profile.

2. The color converter according to claim 1, further comprising an extraction unit that extracts, from the source profile, a basic characteristic indicating reproduction characteristics of main colors in the device used for generating the input image, wherein
the memory stores the color conversion parameter so that the color conversion parameter is associated with the identification information including the basic characteristic extracted by the extraction unit.

3. The color converter according to claim 2, further comprising a determination unit that determines, on the basis of a result of comparison between a first basic characteristic and a second basic characteristic, whether or not to use, in the conversion unit, a color conversion parameter stored in the memory so as to be associated with the second basic characteristic, the first basic characteristic being extracted from the source profile by the extraction unit, the second basic characteristic being stored in the memory.

4. The color converter according to claim 3, wherein, the determination unit determines to use, in the conversion unit, the color conversion parameter stored in the memory so as to be associated with the second basic characteristic, in a case where a difference between the first basic characteristic and the second basic characteristic is not greater than a threshold set in advance.

5. The color converter according to claim 1, further comprising an extraction unit that extracts, from the source profile, a basic characteristic indicating tone characteristics of main colors in the device used for generating the input image, wherein
the memory stores the color conversion parameter so that the color conversion parameter is associated with the identification information including the basic characteristic extracted by the extraction unit.

6. The color converter according to claim 5, further comprising:
a correction unit that corrects a tone characteristic of the color data of the input image to a tone characteristic that allows the conversion using the color conversion parameter to be performed, before the color data of the input image is converted into the color data of the output image by the conversion unit by using the color conversion parameter; and
a determination unit that determines whether or not the correction unit corrects the tone characteristic of the color data of the input image, on the basis of a result of comparison between a first basic characteristic extracted from the source profile by the extraction unit and a second basic characteristic stored in the memory.

7. The color converter according to claim 6, wherein, the determination unit determines that the correction unit corrects the tone characteristic of the color data of the input image in a case where a difference between a tone characteristic indicated by the first basic characteristic and a tone characteristic indicated by the second basic characteristic is greater than a threshold set in advance.

8. The color converter according to claim 4, further comprising a setting unit that sets the threshold in accordance with a request from a user.

9. The color converter according to claim 1, further comprising a controller that performs, on the basis of a degree of matching or similarity of a plurality of pieces of identification information stored in the memory so as to be respectively associated with a plurality of color conversion parameters, control so that a specific color conversion parameter among the plurality of color conversion parameters is deleted, in a case where the memory has no capacity to store the color conversion parameter generated by the color conversion parameter generation unit.

10. A color converter comprising:
a color conversion parameter generation unit that generates a color conversion parameter on the basis of a source profile and a destination profile, the source profile indicating a color reproduction characteristic of a device used for generating an input image, the destination profile indicating a color reproduction characteristic of a device used for generating an output image;
a conversion unit that converts color data of the input image into color data of the output image by using the color conversion parameter generated by the color conversion parameter generation unit; and
a memory that stores the color conversion parameter generated by the color conversion parameter generation unit so that the color conversion parameter is associated with identification information of the destination profile.

11. A color conversion method comprising
generating a color conversion parameter on the basis of a source profile and a destination profile, the source profile indicating a color reproduction characteristic of a device used for generating an input image, the destination profile indicating a color reproduction characteristic of a device used for generating an output image;
converting color data of the input image into color data of the output image by using the color conversion parameter; and
storing the color conversion parameter so that the color conversion parameter is associated with identification information of the source profile.

12. A computer readable medium storing a program causing a computer to execute a process for color conversion, the process comprising:
generating a color conversion parameter on the basis of a source profile and a destination profile, the source profile indicating a color reproduction characteristic of a device used for generating an input image, the destination profile indicating a color reproduction characteristic of a device used for generating an output image;
converting color data of the input image into color data of the output image by using the color conversion parameter; and
storing the color conversion parameter so that the color conversion parameter is associated with identification information of the source profile.

13. A computer readable medium storing a program causing a computer to execute a process for color conversion, the process comprising:
generating a color conversion parameter on the basis of a source profile and a destination profile, the source profile indicating a color reproduction characteristic of a device used for generating an input image, the destination profile indicating a color reproduction characteristic of a device used for generating an output image;
converting color data of the input image into color data of the output image by using the color conversion parameter; and
storing the color conversion parameter so that the color conversion parameter is associated with identification information of the destination profile.
